(19) United States
(12) Patent Application Publication
(10) Pub. No.: US 2011/0016481 A1
(43) Pub. Date: Jan. 20, 2011

(54) Electronic Information Request Card Generation and Transmittal System

(76) Inventors: Donald William Hart, Stockton, NJ (US); Walter Maximuck, Stockton, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/502,731

(22) Filed: Jul. 14, 2009

(51) Int. Cl. H04H 60/33

(52) U.S. Cl. 725/13

(57) ABSTRACT

An electronic information card generation and transmittal system generates audience member or user initiated electronic information request cards. Such electronic information request cards (EIRCs) enable broadcasters, network operators, advertisers and program producers to capture and take advantage of the impulse purchase urges, as indicated by the generation of an information request, of the audience members for converting those urges into purchases or information sharing. For example, a network provider/broadcaster notifies an audience member of eligibility to participate in the facility of the system. The audience member signs up to participate in the facility by registering the system for that user. Upon viewing or listening to a program or commercial of interest, the audience member initiates an EIRC through a user interface. The system bundles the user identification with program definition and a system time stamp to form the EIRC, which is sent to an appropriate entity to execute follow-up information delivery.

### BACKGROUND OF THE INVENTION

1. Field of the Invention

This invention relates generally to information sharing, and more particularly to electronically requesting and sharing information based on the request.

2. Description of Related Art

Advertisers and content providers extend significant effort in resources to air their advertisements and content to an audience. Current processes and systems only tell advertisers and content providers that the content is being provided to a given site. Existing processes and systems do not indicate whether or not the audience members at that site are actually experiencing the content.

While there are known approaches to capture information if an audience member is interested to directly contact the advertiser or proceed to purchase, there is currently no method or system designed to capture information on audience members who may only be generally interested or who are unable to capture the advertiser contact information. When this occurs, the potential to follow-up with this segment of the audience and convert them to sales is lost.

Further, there is a significant amount of content presented which generates audience interests, but does not provide the audience with a way to obtain additional information or effect a purchase. Advertisers today are frustrated with their advertisements on television and radio, because while the advertisers can tell that their advertisements are being displayed in A/V form at a specific site, there are currently very limited feedback mechanisms available as to whether the advertisements are actually generating interest.

For example, a source of frustration for audience members exists with cooking shows, where the audience member sees a finished dish of a recipe, but has difficulty getting on a website to find the recipe. It would be beneficial to provide a facility that quickly gets information to the audience member based on the interest of that specific audience member.

FIG. 1 depicts a schematic of a current environment for broadcasting content (e.g., audio and/or video material) to an audience member. Content sources 12 (e.g., advertisers, content providers, networks) provide content 14 to broadcasters 16. The broadcaster 16 is understood to be any entity that manages the audio/video content provided or displayed at a broadcast interface unit, as discussed in greater detail below. The broadcaster 16 transmits the audio/video information as broadcast content 18 to a broadcast transmitter/receiver (also referred to hereinafter as a broadcaster interface unit 20). The broadcast interface unit is understood to be a device (e.g., television, monitor, radio, bill board, blimp, sign, smart phone) that presents the broadcast content to the audience member 22. The broadcast interface unit 20 includes a user interface 24 that provides communication between the audience member 22 and the broadcast interface unit. It is understood that the user interface 24 (e.g., remote, keyboard, keypad) is represented as a separate box of the broadcast interface unit 20 for differentiation by functionality, and not necessarily as a separate physical device, for example, a keypad of a smart phone or radio. Of course, it is understood that the user interface may be a separate physical device of the broadcast interface unit, such as, a remote or keyboard.

If the audience member 22 is interested in a program, such as a pay-per-view or “on demand” program, the audience member can interface with the user interface 24 to send a signal from the broadcast interface unit 20 having display/billing information 26 back to the broadcaster 16. The broadcaster may then use this information to generate a report of audience demographics which may be used in future negotiations with the content providers for pricing. The broadcaster 16 also sends the requested program material to the broadcast interface unit 20 by, for example, removing a blocking filter of the channel. The audience demographics information received by the content sources 12 may be used by respective marketing departments of the advertisers, content providers, and networks to generate general marketing direction or approaches for their outgoing sales efforts. However, there is no direct link to individual audience members 22 because there is nothing known of the individual interest of the particular audience members.

Accordingly, it would be a benefit to enable broadcasters, network providers, advertiser and programmers to gather information regarding audience interest in the content provided at a finer level of granularity based on the audience members' demonstrated interest by enabling audience members to easily act on the impulses to acquire more information (e.g., purchase urges specific information, marketing information) generated by that content. It would also be a benefit to provide a means for audience members to more efficiently communicate their interests in the content to the content sources.

Other known broadcasting systems provide user specific information to audience members upon user request. For example, cable and satellite television interactive systems provide pay-per-view content. In addition, U.S. Pat. No. 6,628,928 to Crosby et al. discloses an interactive radio system for use with broadcast radio stations wherein feedback is provided to subscribers via the internet. However, none of the prior art systems provide a method for the audience member to request follow-up/additional information via a method they define at a point of contact they specify.

All references cited herein are incorporated herein by reference in their entireties.

### BRIEF SUMMARY OF THE INVENTION

While not being limited to a particular theory, the preferred embodiments of the invention include a system for identification and interchange of information between a source and a remote device. An exemplary system includes a broadcaster as the source, and a broadcast interface unit as the remote device. The broadcaster broadcasts source provider content including a specific broadcast content. The broadcast interface unit includes a broadcast receiver that receives and disseminates the broadcast source provider content to an audience member, a user interface that accepts initiation by the audience member of a request for information associated with the specific broadcast content, and a broadcast interface transmitter that transmits the request for information as a request message to the broadcaster. The broadcaster receives the request message as an electronic information request message. The message includes an identification of the audience member, contact information of the audience member, the carrier frequency, and a system time stamp indicating the system time of initiation. It should be understood that system time refers to the time at which the broadcast content on which the audience member is acting was originally transmitted by the broadcaster.

The preferred embodiments of the invention also include a method for identification and interchange of information between a source and a remote device. An exemplary method includes broadcasting source provider content from a broadcaster to a broadcast interface unit, the broadcasting source provider content including a specific broadcast content, receiving and disseminating the broadcast source provider content to an audience member via the broadcast interface unit, accepting a user interface initiation identifying the specific broadcast content as a request for information associated with the specific broadcast content, transmitting the request for information as a request message to the broadcaster, the request message including an identification of the audience member, contact information of the audience member, the specific broadcast content, and a system time stamp indicating the time of selection, identifying audience member specific information based on the specific broadcast content, and broadcasting the audience member specific information to the broadcast interface unit.

The preferred embodiments of the invention further include an electronic information request card generation and transmittal component enabling a broadcaster to capture information requests of an audience member experiencing broadcast content via a broadcast interface unit. An exemplary system includes an audience interface component, a content identification component, a system time capture component, a data storage component and an electronic information request card (EIRC) generation component. The audience interface component enables the audience member to sign-up and initiate an information request. The audience interface component includes the broadcast interface unit as an input/output communication device between the audience member and the broadcaster. The broadcast interface unit includes an audience interface unit having an information request button for dedicated interaction and initiation of the information request. The content identification component identifies the content the audience member is experiencing at the time of the information request initiation as content of interest. The system time capture component identifies the system time that the audience member initiates the information request as a system time stamp. The data storage component includes the memory that stores an audience member profile and communication preferences through which the audience member may be contacted. The EIRC generation component takes data from the audience member profile and the information request, formats an EIRC message including audience member contact information from the audience member profile, the content of interest and the system time stamp, and transmits the EIRC message back to the broadcaster.

### BRIEF DESCRIPTION OF SEVERAL VIEWS OF THE DRAWINGS

The invention will be described in conjunction with the following drawings in which like reference numerals designate like elements and wherein:

FIG. 1 is a schematic of a current environment for broadcasting content to an audience member;

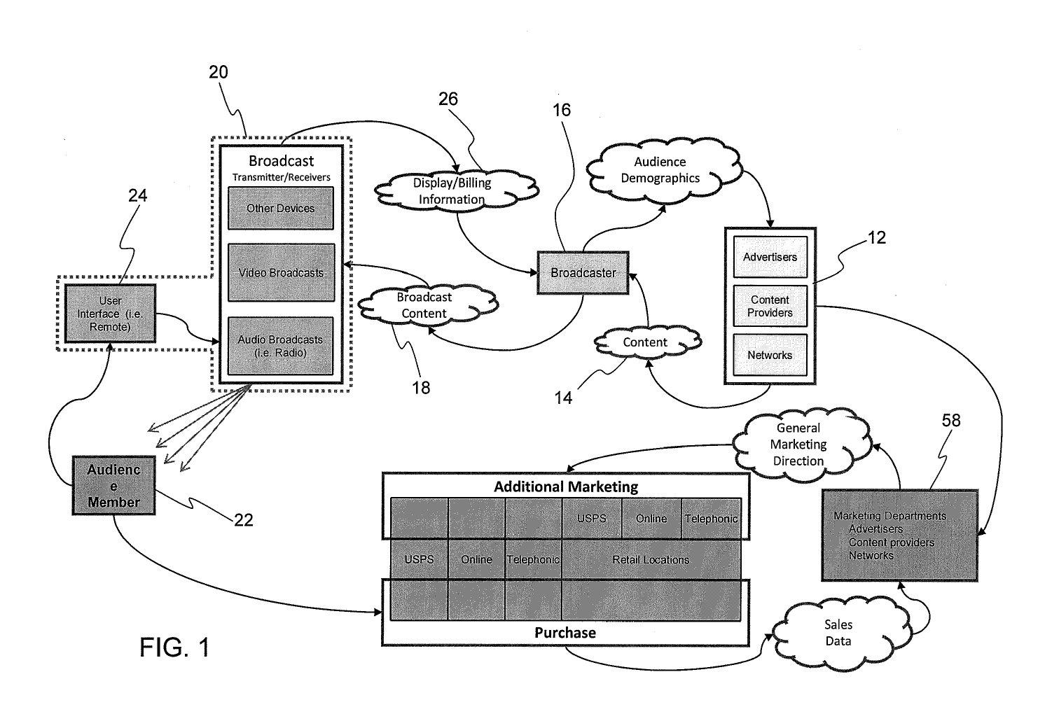

FIG. 2 is a view of an exemplary embodiment of the electronic information card generation and transmittal system as it interfaces with the current environment;

FIG. 3 is a plan view depicting an exemplary approach for audience member registration of the preferred system based on a broadcaster centric environment;

FIG. 4 is a plan view depicting an exemplary approach for audience member registration of the preferred system based on a broadcast interface unit centric environment;

FIG. 5 is a schematic depicting a first cycle of an exemplary broadcaster centric audience information initiation process;

FIG. 6 is a schematic depicting a second cycle of an exemplary broadcaster centric audience information initiation process;

FIG. 7 is a schematic depicting a first cycle of an exemplary broadcast interface unit centric audience information initiation process; and

FIG. 8 is a schematic depicting a second cycle of an exemplary broadcast interface unit centric audience information initiation process.

### DETAILED DESCRIPTION OF THE INVENTION

In accordance with the preferred embodiments of the invention, an electronic information request card generation and transmittal system generates audience member or user initiated electronic information request cards. Such electronic information request cards, also referred to hereinafter as EIRCs, enable broadcasters, network operators, advertisers and program producers to capture and take advantage of the impulse purchase urges and information requests of the audience members for converting those urges into purchases or information sharing. In one example of the preferred embodiments, a network provider/broadcaster notifies an audience member of eligibility to participate in the facility of the system. The audience member signs up to participate in the facility by registering, including providing user information and methods of contact. This initial setup or registration enables the system for that user. Upon viewing or listening to a program or commercial of interest, the audience member initiates an EIRC through a user interface. The system bundles the user identification with program definition and time stamp to form the EIRC, which is sent to an appropriate entity to execute follow-up information delivery. The preferred system that generates the audience member initiated EIRCs includes an audience interface unit, a content identification component, the system time capture, data storage and/or capture and an EIRC generation and transmittal component, as will be described in greater detail below.

With the preferred embodiments, broadcasters can embed commercials in a program for immediate feedback. The broadcast can create an additional revenue stream or an information sharing stream by selling the information per EIRC, sending information back to the advertisers and content providers when an audience member initiates the system. Broadcasters can also sell and provide higher valued advertisement slots for special requested information, thereby matching available products to an audience member's demonstrated interest.

In accordance with an example of the invention, the audience member selected a button of the user interface unit indicating interest in material presented in a segment of broadcast content. The content providers respond by providing additional information associated with the product, thereby enabling information and advertising tailored to fit the demonstrated interest of the audience members.

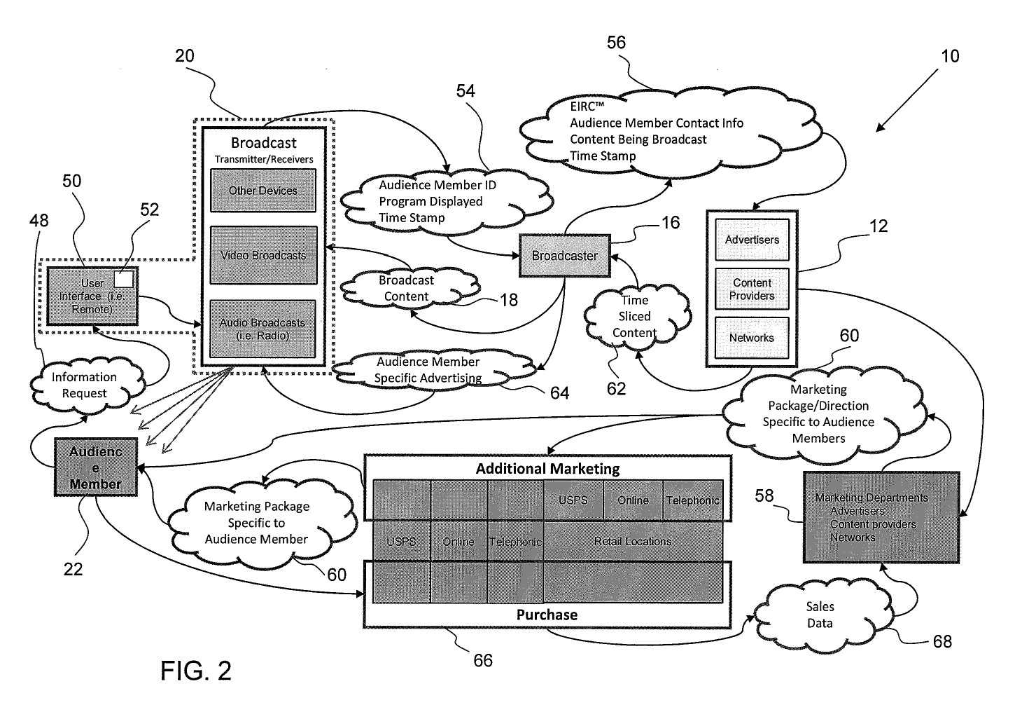

FIG. 2 depicts a schematic of an exemplary embodiment of the electronic information card generation and transmittal system as it interfaces with the current environment. The system 10 includes a broadcaster 16 that broadcasts the content 18 to a broadcast interface unit 20. The broadcast interface unit includes a user interface similar to the audience member interface unit 24, and further including an information request button(s) 52 dedicated for use in the electronic information request card generation and transmittal system. The information request (IR) button 52 is integrated with the transmitter of the broadcast interface unit 20 to transmit an audience member command to generate an information request to the broadcaster 16 upon selection of the button by the audience member.

Still referring to FIG. 2, the content providers 12 provide time sliced content, that is, content sliced into time segments, with each segment of the content associated with an interested third party from an advertising or information standpoint. The broadcaster 16 then sends that information out to the broadcast interface units 20 which transmit that information to the audience member 22. If the audience member 22 sees or hears something of interest for which the audience member wants more information, the audience member pushes the IR button 52 as a command to generate an information request 48 and the transmitter of the broadcast interface unit 20 relays the command via a communication link (e.g., cable, telephone line, internet, electromagnetic link, satellite, radio network ground station, wireless transmitter/receiver, cellular telephone base stations) as understood by a skilled artisan to the broadcaster 16 identifying the audience member, the channel or program carrying the content, and a system time stamp. The system time stamp and channel displayed tells the broadcaster by definition which source providers 12 are interested in the audience member's information request for follow-up.

In a broadcaster centric environment, the audience member identification (ID) enables the broadcaster 16 to fetch the method(s) by which the audience member wishes to be contacted and the address to which that information should be sent. While not being limited to a particular theory, the broadcaster 16 produces an electronic information request card (EIRC) 56 based on the information request sent from the broadcast interface unit 20 for the source providers 12. The EIRC includes the audience member contact information, the content being broadcast to the audience member and the system time stamp of the audience member's initiation of the information request. The broadcaster 16 sends that information to the source providers 12. As can be seen in FIG. 2, the source providers can forward that information to a respective marketing department 58 to provide an information or marketing package 60 specific to the audience member.

Preferably, the marketing (or information) package 60 is then sent to the audience member 22 in accordance with the audience member's contact information. For example, if the contact information includes a residence address, the information/marketing package 60 can be sent to the audience member's home address. Similarly, if the contact information includes an email address, then the information/marketing package 60 can be sent to an email address of the audience member. Further, if the audience member leaves a telephone number in the contact information, then the audience member can be reached with the information/marketing package 60 by telephone (e.g., voice, text messaging). If the audience member 22 makes a purchase based on the information/marketing package 60, then the purchase 66 and sales data 68 is forwarded back to the respective marketing department 58 associated with the purchase.

In the example shown in FIG. 2, a preferred approach for contacting the audience member is via the initial channel of the broadcast content 18. In particular, the contact providers 12 send time sliced content 62 to the broadcasters 16 which broadcasts the content as audience member specific information or advertising 64 to the broadcast interface unit 20 which shows that specific information or advertising to the audience member.

While not being limited to a particular theory, the audience member specific information or advertising 64 is preferably brought to the audience member 22 via the channel, station or frequency that the audience member is watching or listening to. That is, the audience member specific information or advertising can override default advertising meant for the audience member 22 that has shown interest in receiving the specific information. For example, during a next commercial break in a television or radio show, the broadcaster 16 can transmit audience member specific information and advertising 64 to the broadcast interface unit 20 during the commercial time slot instead of the general commercial that would normally be shown, as understood by a skilled artisan. In this matter, the broadcaster 16 now as the opportunity to provide audience member specific information or advertising 64 as more highly valued communication which could be the marketing package, opportunistic information or advertising on the part of potential competitors of the initial interest generator. For example, for an initial interest generator selected during a Ford 150 commercial, the broadcaster 16 may pump back to the audience member 22 competitor's truck commercials from General Motors, Honda, Toyota, or other truck makers. In addition, the broadcaster 16 may pump back to the audience member 22 commercials or information in areas of interest related to the initial interest generator, such as, fishing, motor sports or dog food.

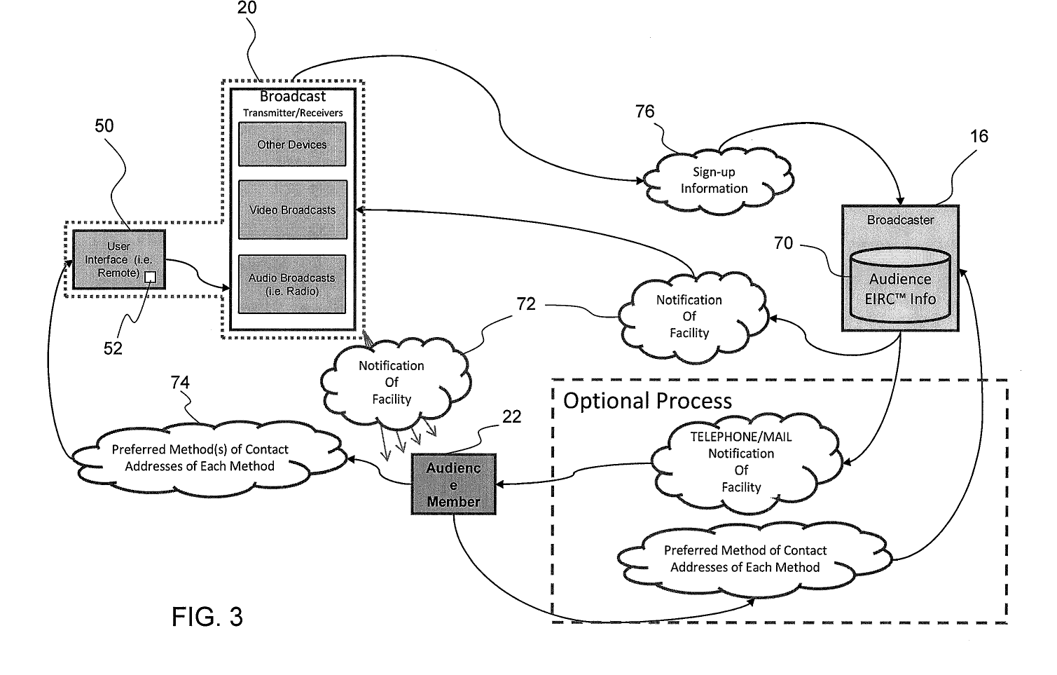

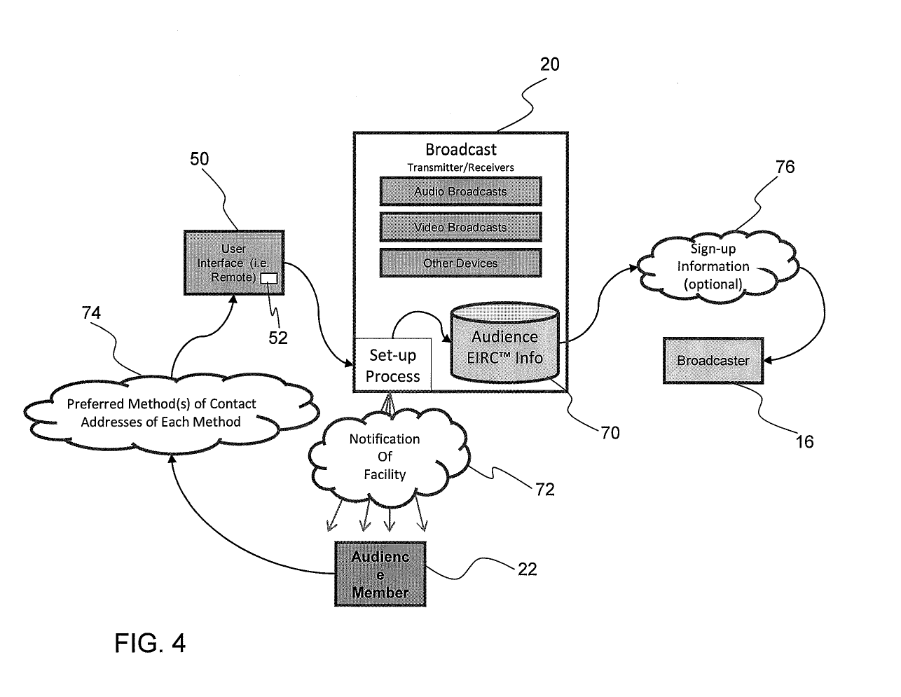

FIGS. 3 and 4 are diagrams depicting the exemplary approaches for audience member registration of the electronic information card generation and transmittal system 10. In particular, FIG. 3 shows an example of a first process based on a broadcaster centric environment, and FIG. 4 depicts a second process based on a broadcast interface unit centric environment. While not being limited to a particular theory, the determination of whether the sign-up or registration process is broadcaster centric or broadcast interface device centric depends primarily on the location of a storage unit 70 that stores audience EIRC information. That is, the broadcaster 16 stores the audience EIRC information in a broadcaster centric environment, and the broadcast interface unit or device 20 stores the audience EIRC information in a device centric environment.

Referring to FIG. 3, in a broadcaster centric sign-up process, with a user/audience member 22 participating in a television reception service (e.g., cable, satellite) the user sets up a corresponding cable/satellite box of the broadcast interface unit 20. During the set-up, the user is forwarded a notification of facility message 72 of the electronic information card generation and transmittal system available to the audience member. If the audience member 22 declines to participate, then nothing further happens between the audience member and the facility. If the audience member decides to participate, then the audience member selects a preferred method or methods of contact 74, with the address of each method (e.g., email address, home address, phone number, cable/satellite service contact information). This information is sent back to the broadcaster as sign-up information 76 and is stored in memory at the broadcaster as audience EIRC information. Alternatively, the audience member 22 can sign-up with the facility via other means (e.g., telephone, mail, email) of communication between the audience member and the broadcaster 16, as readily understood by a skilled artisan. After registration, the audience member can be notified by telephone, mail, email, etc. of a facility and can respond by mail or telephone back to the broadcaster, for example, radio. In other words, when an audience member 22 buys, for example, a car, the audience member can sign up for the radio EIRC service and the broadcaster can follow-up via mail to the user's stored address.

Now referring to FIG. 4 for the broadcast interface unit centric sign-up, instead of registering with a broadcaster, the audience member sets up their device (e.g., cable box, satellite box, computer for internet service) and receives notification of the facility in a manner similar to setting up parental filters. The audience member selects the preferred method of contact and defines the point of contact through the user interface 50. The sign-up information is stored locally at the broadcast interface unit box. When the audience member later initiates an EIRC this information is accessed to generate the EIRC.

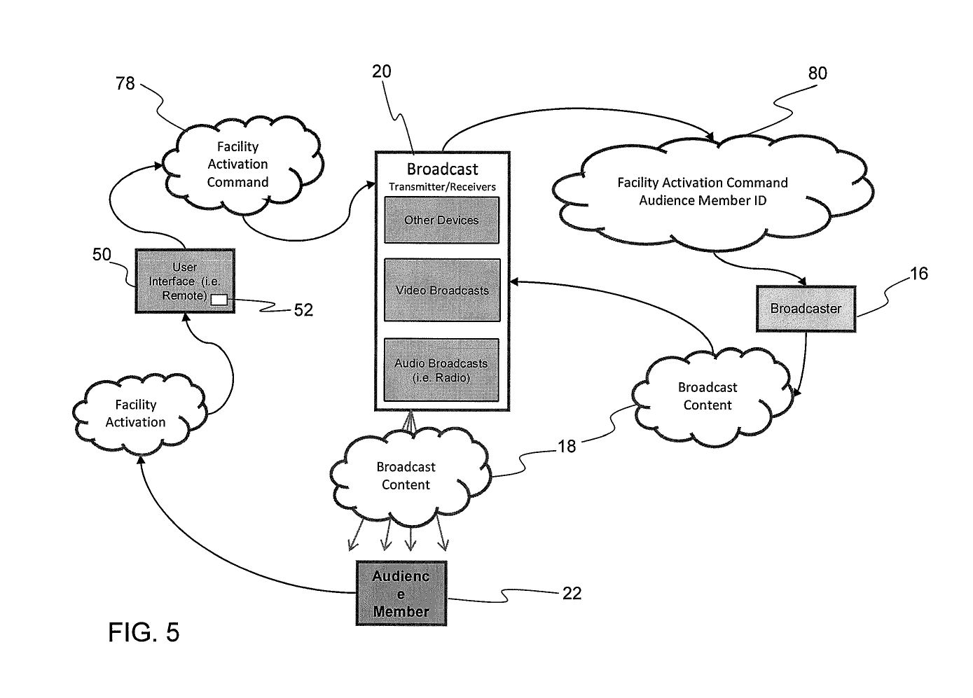

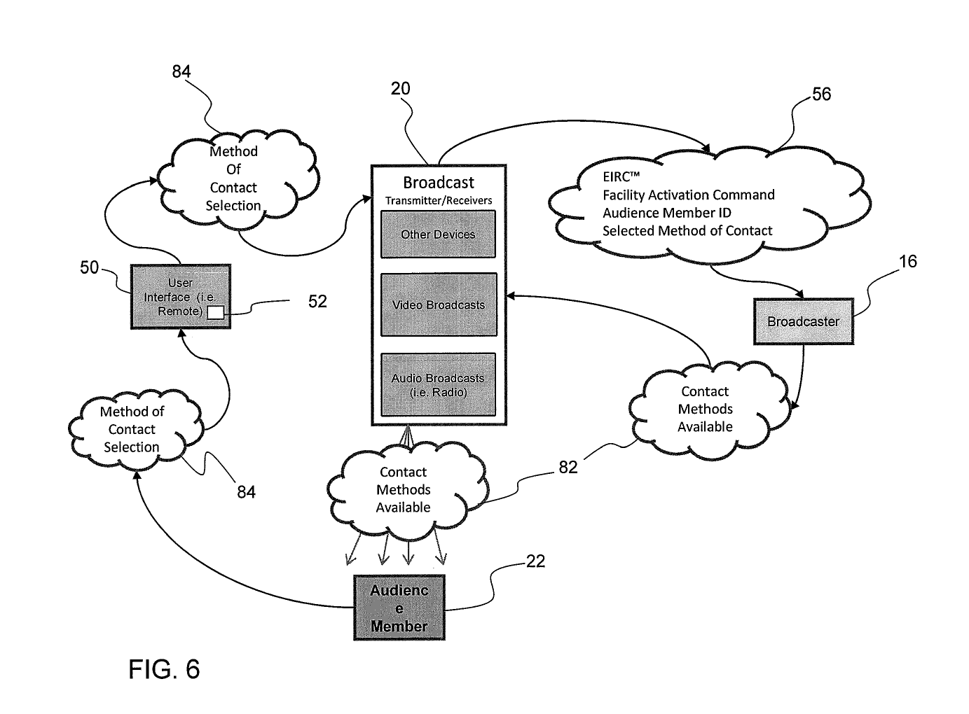

FIGS. 5 and 6 depict first and second cycles of an example broadcaster centric audience information initiation process. As can be seen in FIG. 5, the broadcaster sends broadcast content to the broadcast interface unit 20, which provides that broadcast content to the audience member. The audience member 22 sees something of interest. With the system 10, the audience member initiates the facility, preferably by entering a facility activation command 78 through the user interface 50, and most preferably through the information request button 52. The broadcast interface unit 20 sends a facility activation command 80 from the user interface to the broadcaster 16 with the audience member's ID, telling the broadcaster that the facility is activated. If the audience member 22 has more than one method of contact, the broadcaster sends a list of contact methods available message 82 (FIG. 6) to the audience member via the broadcaster interface unit 20. The audience member selects a preferred method or methods of contact 84 and relays that information back to the broadcast interface unit which forwards the selected method or methods of contact with the EIRC 56, including the audience member contact information, the content being broadcast and the time stamp. The broadcaster 16 then processes the EIRC in accordance with the relationships in place with the broadcasters content providers to forward the selected information content to the audience member 22 via the audience member's preferred (e.g., selected) method of contact.

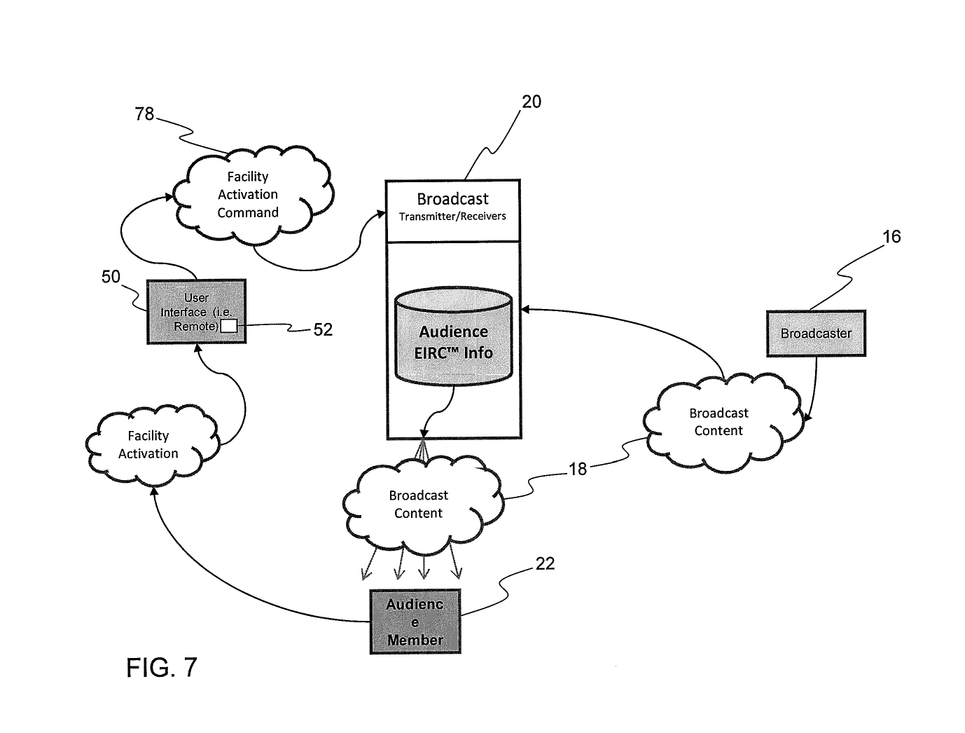

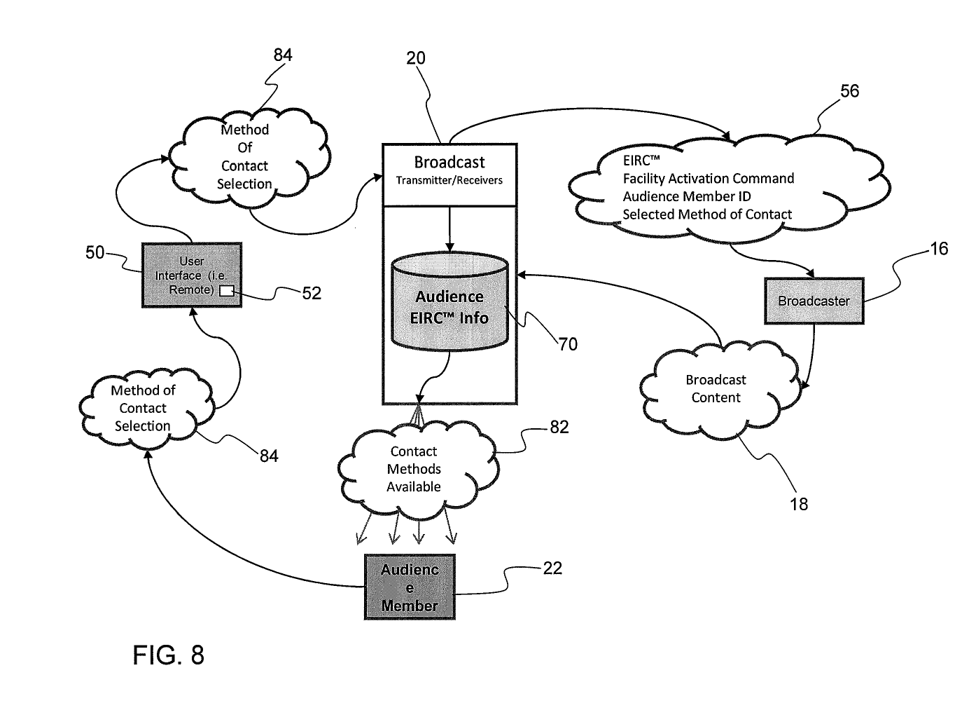

FIGS. 7 and 8 depict schematics of first and second cycles, respectively, of an exemplary device (e.g., broadcast interface unit) centric audience information initiation process. Referring to FIG. 7, broadcast content 18 is shown to the audience member 22 via the broadcast interface unit 20. The audience member 22 activates the facility through the user interface 50. For example, the audience member enters a facility activation command 78 to the broadcast interface unit 20. The broadcast interface unit accesses audience member information from the storage unit 70 and presents the available methods of contact 82 to the audience member. The audience member selects a preferred method or methods of contact 84 through the user interface 50, which is forwarded to the broadcast interface unit 20. The broadcast interface unit 20 then generates the EIRC 56 and transmits it to the broadcaster 16 with the audience member ID, content, time stamp, and selected method of contact. The broadcaster 16 processes the eIRC in accordance with the relationships in place with the broadcasters content providers to send the audience member specific information to the audience member via the selected method of contact. If the audience member during set-up only selects one method of contact, then the second loop for method of contact selection is not needed and the broadcast interface unit 20 forwards the EIRC 56 to the broadcaster with the selected single method of contact.

The preferred system includes the audience interface unit 50 having an information request button 52, and the broadcast interface unit 20 provides contact with the broadcaster. In general, the electronic information card generation and transmittal system preferably includes a set of components including an audience interface component, a content identification component, a system time capture component a data storage and/or capture component and an EIRC generation component as noted above and discussed in greater detail below.

The audience interface component includes the structure that enables audience member sign-up and initiation of the facility, which is preferably but not necessarily an integral component of the broadcast interface unit 20. As noted above, the audience interface unit 50 includes an information request button 52 for dedicated interaction and initiation of the system. The information request button is preferably a dedicated switch located on the audience interface unit as, for example, a key or toggle switch on a remote controller, radio keypad, steering wheel mounted keypad, keyboard of a computer or satellite/cable box. It is understood that the audience interface may also include as the audience interface unit, a card reader, for example, in a cable/satellite box for reading smart cards, connected to a computer, or a keypad of a smart phone in communication with the broadcaster via the internet. It is interesting to note that for a smart phone, the audience interface unit would be a component within the broadcast interface unit which would include a transmitter/receiver that would interface with the smart phone or similar devices through infra-red, laser or other similar technologies. This approach would also be used for a broadcast interface unit that is a single channel display (e.g., blimp, bill board).

Accordingly, the audience interface component depends on the type of communication from the audience member. For a radio, the audience interface component would include a dedicated button on the radio or on a steering wheel of a vehicle carrying the radio. The audience interface component could also be a device which receives a signal from another device being operated by the audience member (e.g., smart phone, PDA) sending a laser beam to a bill board or even a blimp. This technology currently exists with smart phones, such as Palms, iphones and Blackberries. As noted above, the audience interface component could also be a reader next to a television, especially in a public viewing location where a user's smart card could be read by the reader as a demonstration of interest in information being shown on the television at that time. In this example, the reading of the swipe card acts as both the sign-up and initiation for the EIRC facility, with the default form of contact being the mailing address of the user of the smart card. Accordingly, the audience interface component enables the user to sign up and initiate the facility.

The content identification component identifies the content the audience member is experiencing at the time of the EIRC initiation. The content identification component may already be available for a person watching television via a cable or satellite television box, for example, as used in signing up for pay-per-view or “On Demand”. The content identification can also be the radio frequency tuned in by a radio, the channel for television, the URL for internet usage, etc. The content identification can also be induced, for example, when only one channel is available for broadcast. For example, a Goodyear blimp provides a certain content package available for viewing at a certain time. The system does not know what channel is being looked at because there is only one channel. This also applies to bill board information and advertising, even though the advertising sources can change their content periodically. While not being limited to a particular theory, the blimp, bill board or other display preferably includes a receiver than can read an interface signal or laser beam from a smart phone or PDA and send an EIRC for information to be sent back to the user of the smart phone. In this case, the content is induced, that is, derived at by induction because there is only one content available which, if needed, can be determined by the time slice of the content.

The system time capture component identifies the time of the system that the broadcast content was originally broadcast by the broadcaster and which the audience member is experiencing when they activate the electronic information request card. The time is defined by the time of the system, not by the clock time to the user in the user's respective time zone.

The data storage or capture component is the memory that stores the audience member identification information, available response methods and contact point definition for each response method. In other words, the data storage and/or capture component is the component that stores the audience member profile and communication preferences for each of the members or users. In the event the broadcast interface unit is configured such that sign-up and activation are accomplished at the same time, (card reader) this component merely stores the information long enough for the system to generate the EIRC

The electronic interface request card (EIRC) generation and transmittal component takes information from the audience member profile and the information request (e.g., the content, time slice, preferred method(s) of follow-up, the contact point(s) for the follow-up message), formats an EIRC message, and transmits the message back to the broadcaster. The broadcaster is understood to include the entity that manages the display (e.g., blimp, bill board) or the entity responsible for the presentation of the information to the audience. This is different than a source provider, which includes a producer of a television show that provides the content to the broadcaster that then presents it to the audience along with other shows. Other source providers include advertisers, networks, or other entities depending on the information request. For example, for a travel documentary, if initiation of the information request takes place in the first ten minutes of the program, which is describing the Ritz Carlton Hotel in New York City, the EIRC would go to the hotel. If the second ten minutes of the documentary focuses on travel to Rome, the information that is in the EIRC should be sent to a participating hotel in Rome, or to a travel agency familiar with the region. If the documentary includes a commercial for a Ford pick-up, then the EIRC should go to Ford for Ford to send information on a specific vehicle being presented, including applicable dealer incentives, rebates, a list of local dealers and coupons. Alternatively, the EIRC initiated during the Ford truck commercial can go to competitors or associated information providers, such as, General Motors, Honda, Toyota, Dodge, or a promoter for a local car show or auction.

It is understood that the electronic information card generation and transmittal system and methods thereof described and shown are exemplary indications of preferred embodiments of the invention, and are given by way of illustration only. In other words, the concept of the present invention may be readily applied to a variety of preferred embodiments, including those disclosed herein. While the invention has been described i n detail and with reference to specific examples thereof, it will be apparent to one skilled in the art that various changes and modifications can be made therein without departing from the spirit and scope thereof. Without further elaboration, the foregoing will so fully illustrate the invention that others may, by applying current or future knowledge; readily adapt the same for use under various conditions of service.

What is claimed is:

1. A system for identification and interchange of information between a source and a remote device, comprising:
a broadcaster as the source, the broadcaster broadcasting source provider content including a specific broadcast content;
a broadcast transmitter/receiver including a user interface, a broadcast receiver and a message transmitter, the broadcast interface unit to receive and disseminate the broadcast source provider content to an audience member, the user interface to accept a command to activate the EIRC generation facility, and the broadcast interface transmitter to transmit the command for information to the broadcaster; and
an electronic information request card as the request for information, the electronic information request card including an identification of the audience member, contact information of the audience member including a preferred method of contact, the specific broadcast content being experienced by the audience member when the EIRC generation command is activated, and a system time stamp indicating the time of command activation,
wherein the broadcaster activates the forwarding of the audience member specific information to the audience member via the preferred method of contact.

2. The system of claim 1, the broadcaster including a memory for storing audience EIRC information including a method of contact with an address of the audience member for the method of contact.

3. The system of claim 2, the method of contact including a plurality of methods of contact, each of the methods of contact having a respective address associated with the audience member.

4. The system of claim 1, wherein the broadcaster reads the contact information of the audience member from the electronic information request message, and transmits a list of the plurality of methods of contact to the broadcast interface unit, receives a selection of one of the plurality of methods of contact, and facilitates the distribution of the audience member specific information to the audience member via the selected one of the plurality of methods of contact.

5. The system of claim 1, the broadcast interface unit further including a memory for storing audience EIRC information including a preferred method of contact with an address of the audience member.

6. The system of claim 5, the method of contact including a plurality of methods of contact, each of the methods of contact having a respective address associated with the audience member.

7. The system of claim 6, wherein the broadcast interface unit reads the selection of the specific broadcast content from the user interface, disseminates a list of the plurality of methods of contact to the audience member, receives a selection of one of the plurality of methods of contact, and transmits the request for information as a request message to the broadcaster with the selected one of the plurality of methods of contact for the distribution of the audience member specific information to the audience member via the selected one of the plurality of methods of contact.

8. The system of claim 1, the interface unit including a dedicated selection button that actuates the request for information.

9. A method for identification and interchange of information between a source and a remote device, comprising:
broadcasting source provider content from a broadcaster to a broadcast interface unit, the broadcasting source provider content including a specific broadcast content;
receiving and disseminating the broadcast source provider content to an audience member via the broadcast interface unit;
accepting at a user interface an information request identifying the specific broadcast content as the content for which an electronic request for information is associated;
transmitting a facility activation command as a request message from the user interface, the request message including an identification of the audience member, the specific broadcast content, and a system time stamp indicating the time of selection;
transmitting stored audience member contact information to the audience member via the broadcast interface unit;
accepting a user interface selection of the preferred method of contact from the audience member through the user interface;
generating an electronic information request card (EIRC) by the broadcast interface unit, the EIRC including the specific broadcast content, the system time stamp, and contact information of the audience member with the preferred method of contact;
transmitting said EIRC from the broadcast interface unit to the broadcaster;
identifying audience member specific information based on the EIRC; and
transmitting the audience member specific information to the audience member via the preferred method of contact.

10. The method of claim 9, further including storing the identification of the audience member and the contact information of the audience member, the contact information including an approach of contact with an address of the audience member.

11. The method of claim 10, the approach of contact including a plurality of approaches of contact, each of the approaches of contact having a respective address associated with the audience member.

12. The method of claim 11, further comprising reading the contact information of the audience member from the request message, displaying a list of the plurality of approaches of contact at the broadcast interface unit, receiving a selection of one of the plurality of approaches of contact, and distributing the audience member specific information to the audience member via the selected one of the plurality of approaches of contact.

13. The method of claim 9, further comprising actuating the request for information via a dedicated selection button.

14. An electronic information request card generation and transmittal system enabling an audience member to act on an impulse urge generated by experiencing broadcast content via a broadcast interface unit by initiating the command to generate an electronic information request card, and enabling a broadcaster to capture the impulse urge and convert the impulse urge for targeted allocation of audience member specific information based on the demonstrate interest of the audience member, the system comprising:
an audience interface component, a broadcast content identification component, a system time capture component, a data storage component and an electronic information request card (EIRC) generation component;
the audience interface component enabling the audience member to sign-up and initiate an electronic information request, the audience interface component including the broadcast interface unit as an input/output communication device between the audience member and the broadcaster, the broadcast interface unit including an audience interface unit having an information request button for dedicated interaction and initiation of the information request;
the content identification component identifying the content the audience member is experiencing at the time of the information request initiation as a content of interest;
the system time capture component identifying the time that the system identifies as the time the system broadcast the content being presented to the audience member at the time the audience member initiates the information request as a system time stamp;
the data storage component being the facility that stores an audience member profile and communication preferences to contact the audience member; and
the EIRC generation component taking data from the audience member profile and the information request, formatting an EIRC message including audience member contact information from the audience member profile, the broadcast frequency over which the content of interest was originally broadcast and the system time stamp, and transmitting the EIRC message back to the broadcaster.
